(19) United States
(12) Patent Application Publication
(10) Pub. No.: US 2005/0087632 A1
(43) Pub. Date: Apr. 28, 2005

(54) Storage and transport container for a metering head

(76) Inventor: Ulrich Rosenbaum, Wangs (CH)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/966,422

(22) Filed: Oct. 15, 2004

(30) Foreign Application Priority Data
Oct. 27, 2003 (DE) 103 50 030.8

(51) Int. Cl. B05B 1/30

(52) U.S. Cl. 239/585.1

(57) ABSTRACT

A storage and transport container for a fuel metering head has an envelope (10) the receiving space (11) of which is filled with a swelling medium (12) for swelling sealing elements associated with the metering head (20).

### BACKGROUND OF THE INVENTION

1. Field of the Invention

The present invention relates to a storage and transport container for a fuel metering head and, in particular, for a fuel metering head for gaseous or liquid fuel-driven setting tools, and having an envelope with a receiving space for the metering head.

2. Description of the Prior Act

Storage and transport containers of the type described above are used for protecting metering heads, which are stored and transported therein, from outside influences, damage, etc. Thus, the firm HILTI Aktiengesellschaft, the assignee herein, uses special packaging for storing and transporting metering heads for the setting tool GX100. On the metering head, there are arranged sealing elements formed, e.g., of rubber. In the packaging, these sealing elements can shrink or become brittle. When the metering head is removed from its packaging and is mounted on a setting tool and secured to the fuel vessel, the sealing elements begin slowly to swell. The swelling affects the metered-out amount of the fuel that the metering head supplies for a setting process. The change in the amount of the metered fuel negatively influences combustion in the setting tool and adversely affects the quality of the setting process.

British Publication GB2350347A discloses a bag for storing objects in a controlled atmosphere. To this end, the bag is provided with inlet valve and an outlet valve. Through the inlet valve, the moisture displacer can be brought in the bag, and through the outlet valve, it can be aspirated from the bag. The drawback of the storage bag disclosed in the British reference consists in that it cannot be used for storing metering heads and, in particular, for storing fuel metering heads with sealing elements.

Accordingly, an object of the present invention is to provide a storage and transport container suitable for storing and transporting fuel metering heads with sealing elements, in particular.

### SUMMARY OF THE INVENTION

This and other objects of the present invention, which will become apparent hereinafter, are achieved by providing a storage and transport device having an envelope the receiving space of which is filled with a swelling medium for swelling the sealing elements of the fuel metering head. The filling of the envelope receiving space with a swelling medium permits to create in the storage and transport container an atmosphere that swells the sealing elements of a metering head located in the container. When so stored and transported metering head is used, e.g., in a setting tool, the amount of the metered-out fuel does not change.

Advantageously, the swelling medium consists of one or several hydrocarbons having a boiling point of more than 50° C. Ideally, these hydrocarbons are similar to the material that is metered out by the metering head, e.g., similar to a fuel gas but have a lower vapor pressure. This permits to achieve storage conditions optimally adapted to the subsequent use of the metering head with its sealing elements.

Advantageously, the swelling medium consists of one or several hydrocarbons selected from the group containing heptane, octane, dipropylether, nitromethane, methanol and ethanol. These materials insure good swelling values of sealing elements and are user-friendly. According to an advantageous embodiment of the storage and transport container according to the present invention, a storage element for the swelling medium is arranged in the receiving space of the container. The storage element prevents leaking out of the swelling medium when the metering head is removed from the container. Preferably, the storage element is formed as a sponge.

Advantageously, the envelope is formed as a foil bag or a foil packaging. Forming the bag of a foil permits to easily produce it and make it light and flexible.

It is further advantageous when the envelope is formed as a pin-on cap. A cap can also be easily produced, it has a high stability and, therefore, provides a good protection against the mechanical loads. Further, with formation of the envelope as a cap, only the openings (inlet, outlet) of the metering head are covered.

Advantageously, the pin-on cover cap or caps is (are) provided with at least one sealing element for sealing the receiving space against the surrounding atmosphere when the cap (caps) is (are) pinned on the metering head.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a perspective, partially cut open view of a storage and transport container according to the present invention with a metering head arranged therein; and

FIG. 2 a cross-sectional view of another embodiment of a storage and transport container according to the present invention with a metering head arranged therein.

### DETAILED DESCRIPTION OF THE PREFERRED EMBODIMENTS

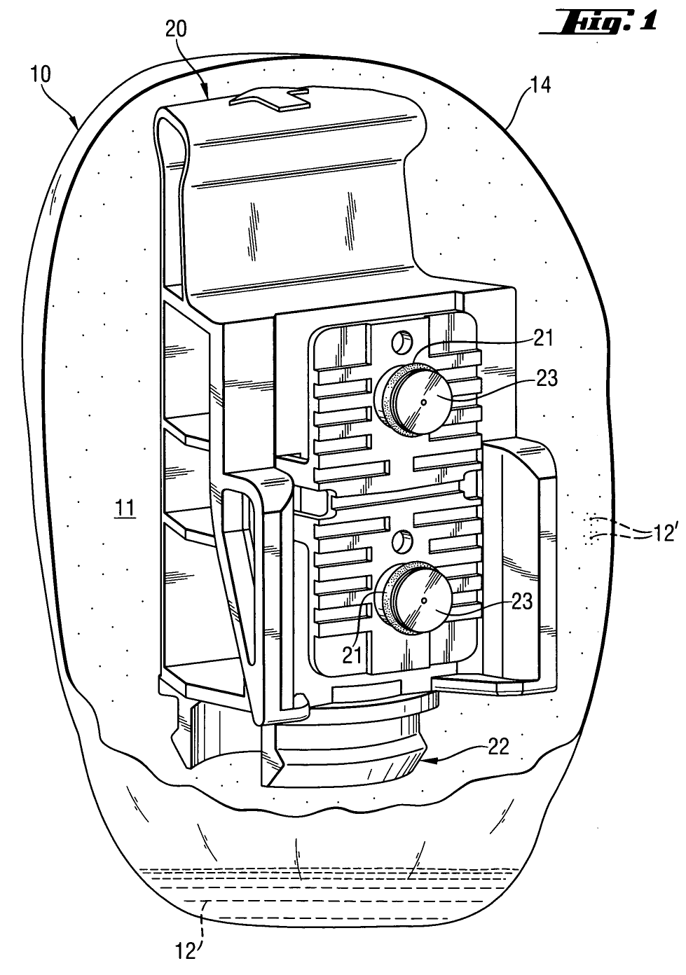

A storage and transport container, according to the present invention, which is shown in FIG. 1, is formed as a medium-tight closed envelope 10 in form of a foil bag 14. In the receiving space 11 of the envelope 10, a metering head 20 for a setting tool is located. In addition to the metering head 20, there is provided in the envelope 10 a swelling medium 12 such as, e.g., heptane, octane, dipropylether, nitromethane, methanol, ethanol, or their mixture. The metering head 20 has a connection section 22 with which the metering head 20 is connected to a fuel container. A connection section 23 connects the metering head 20 to a setting tool. Different sealing elements 21, which are formed, e.g., of rubber, are provided on the connection section 23 and in the interior of the metering head 20. These sealing elements swell under the atmosphere that predominates in the receiving space 11 of the envelope 10 and which is formed of the vapor phase 12 of the swelling medium.

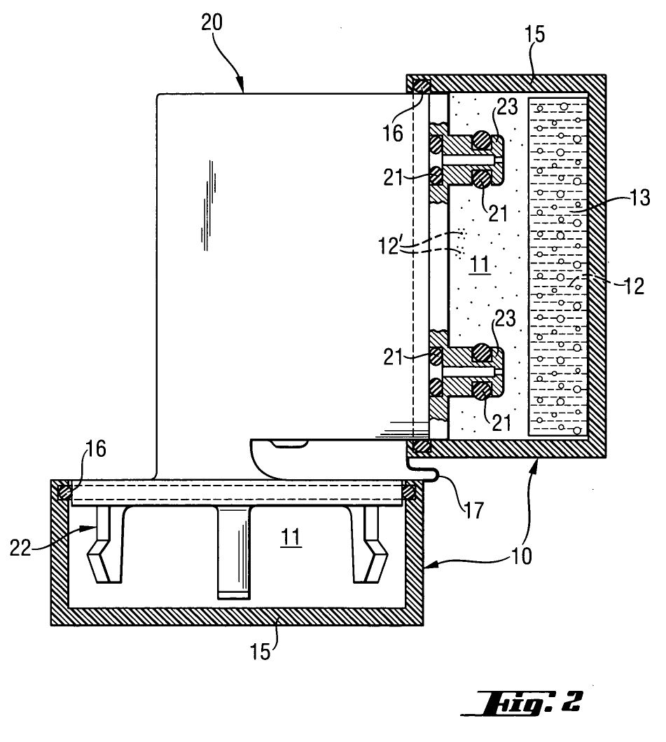

FIG. 2 shows another embodiment of a storage and transport container according to the present invention. The envelope 10 of this embodiment of the storage and transport container is formed of two cover caps 15 which are connected with each other by a film hinge 17. Each of the two cover caps 15 is provided with a sealing element 16 extending along the inner periphery of the cap at the cap top. The sealing elements 16 seal the metering head 20 on which the cover caps 15 are pinned on. The sealing elements 16 retain the caps 15 on the metering head 20 frictionally, forcelockingly, or formlockingly. The receiving space 11 of each of the cover cap 15 is circumferentially medium-tight closed. In the receiving space 11, in which connection sections 23 of the metering head 20 are located, there is also arranged a storage element 13 for the swelling medium 12 which is formed as a sponge. The storage element 13 prevents the liquid swelling medium 12 from leaving the receiving space 11 when the metering head is removed from the envelope 10. It should be noted that the swelling medium 12 can also fill the receiving space 11 of another cover cap 15 in which the connection section 22 is located.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

1. A storage and transport container for a fuel metering head, comprising envelope means (10) having a receiving space (11) for the fuel metering head (20); and a swelling medium (12) filling the receiving space (11) for swelling different sealing means (21) associated with the metering head (20).

2. A storage and transport container according to claim 1, wherein the swelling medium (12) consists of a hydrocarbon having a boiling point greater than 50° C.

3. A storage and transport container according to claim 1, wherein the swelling medium (12) comprises at least one hydrocarbon medium selected from the group containing heptane, octane, dipropylether, nitromethane, methanol, ethanol.

4. A storage and transport container according to claim 1, wherein a storage element (13) for the swelling medium (12) is located in the receiving space (11).

5. A storage and transport container according to claim 4, wherein the storage element (13) is formed as a sponge.

6. A storage and transport container according to claim 1, wherein the envelope means (10) is formed as a foil bag (14).

7. A storage and transport container according to claim 1, wherein the envelope means (10) comprises at least one cover cap (15).

8. A storage and transport container according to claim 7, wherein a sealing element (16) is provided on at least one cover cap (15).
